(19) United States
(12) Patent Application Publication
(10) Pub. No.: US 2017/0138594 A1
(43) Pub. Date: May 18, 2017

(54) APPARATUS FOR ENHANCING PERFORMANCE OF FUEL COMBUSTION

(71) Applicant: DHITI TOWIWAT, Bangkok (TH)

(72) Inventor: DHITI TOWIWAT, Bangkok (TH)

(21) Appl. No.: 15/121,208

(22) PCT Filed: Mar. 2, 2015
(86) PCT No.: PCT/TH2015/000015

§ 371 Date: Aug. 24, 2016

(30) Foreign Application Priority Data
Feb. 28, 2014 (TH) 1401001103

(51) Int. Cl. F23K 5/08; H05F 3/00

(52) U.S. Cl. CPC F23K 5/08; H05F 3/00

(57) ABSTRACT

This invention demonstrate the apparatus for enhancing the performance of fuel combustion having tubes comprised of woven filaments in the form of a net made of metal or non-metal materials having the property of reducing static charges between molecules. The invention as disclosed herein will allow the better distribution of gas mass. The spaces between molecules of gas mass can enhance its flammable property and allow complete combustion. With the same amount of gas used, the heat and energy obtained will also increase.

### FIELD OF INVENTION

Engineering in relation to an apparatus for enhancing performance of fuel combustion

### BACKGROUND OF THE INVENTION

Static electrical charges can occur on any material or liquid. When liquid (such as solvents, petroleum, or fuel) touch or come into contact with a surface of another material such as the material of the container for such liquid or a tube for temporarily allowing the liquid to pass through which may be used for pouring, pumping, filtering, stirring, shaking, or passing of said liquid through tubes. The said touch or contact causes static electrical charges. Even for fluid that is transferred, used, or stored in non-conductive containers, electrical charges can still occur when another material moves against the external surface of the container. The amount of the electrical charges that occurs depends on the amount of liquid and the flow speed in the stirring/shaking.

Generally, every apparatus that is conductive and related to flammable substance needs to be connected to a ground in order to prevent the accumulation of static electrical charges and reduce the likelihood of ignition due to such static electrical charges. Conductive apparatuses include vessels, containers, stirring devices, pumping devices, valves, connectors, flanges, and any connecting apparatus of the aforementioned, and all are required to have a connection to a ground.

However, solvent and fuel from petroleum (such as benzene, toluene, mineral, spirit, gasoline, jet fuel) which can cause static electrical charges when pouring or flowing in a tube or a hose tend to accumulate electrical charges since the said substances do not have a conductive property to the extent that it is capable of supporting the transfer to the electrical charges via a grounding configuration.

The transfer of liquid from one container to another container may therefore cause electrical charges and sparks. Hence, in order to prevent such electrical charges and sparks from occurring, which may lead to a fire situation, it is important to have a bonding between the containers prior to the transfer. Bonding can be done by having an electrical connection between one metal container and the other metal container so that both containers will have the same voltage and not cause any electrical sparks. One of the bonding methods is to use a special metal strip or metal wire to connect and secure both containers. The other method is to control the speed and flow rate while pouring and stirring flammable liquid during the filling which may cause a collision or splash and subsequently cause electrical charges on the liquid filled into the container or vessel.

Using the bottom filling method will reduce these risks in filling. For this method, the filling is done through a filling opening at the bottom of the container or through the use of a grounded conductive dip pipe. A dip pipe is a tube connecting the filling opening at the upper portion of container to the area around the bottom of the container. This will allow the tube to be immersed in the filled liquid thereby minimizing disturbances when additional liquid is filled in.

Therefore, it is necessary to improve and develop apparatuses that can reduce the problems and issues caused by electrical charges and also improve performance at the same time.

### SUMMARY OF THE INVENTION

The objective of this invention is to develop and improve the apparatus for increasing the combustion performance of fuel and increasing the heat by reducing the static electrical charges between molecules, thereby reducing the electrical charges occurring from the flow of fuel and air. The invention as disclosed herein will allow the better distribution of gas mass. The spaces between molecules of gas mass that can contact oxygen will increase and enhance its flammable property and allow complete combustion. With the same amount of gas used, the heat and energy obtained will also increase.

As disclosed, the apparatus for enhancing the performance of fuel combustion according to this invention comprises a tube made from metal or non-metal filaments contained and arranged within the said tube made where the metal or non-metal materials have the property of reducing static charges wherein the filaments are woven as a net and said net is arranged to be positioned along the tube wall inside the tube. In one aspect, the filaments are woven into the form of a rectangular-shaped net or a rhombus-shaped net. In the other aspect, the filaments are round wires or flat wires. The said filaments can be woven as a net and said net arranged to be positioned along the tube wall inside the tube in the form of a cylinder. The said net can also be arranged in a woven form and positioned along the tube wall inside the tube. The metal used for making the tube or filament is selected at least one from the group of iron, aluminium tin, nickel, bronze, silver, platinum, or gold.

The objectives and unique characteristics and other aspects of this invention will be described in more detail by way of the examples and drawings included and the best mode will also be further described.

### BRIEF DESCRIPTIONS OF THE DRAWINGS

FIG. 1 shows the woven filaments as a net arranged to be positioned along a tube wall by using the method of flat rolling.

FIG. 2 shows the woven filaments as a net arranged to be positioned along a tube wall by using the method of corrugate rolling.

FIG. 3 shows the roll of woven filaments as a net which is positioned along the tube wall by using the method of random rolling

FIG. 4 shows the woven filaments as a net that is replaceable.

FIG. 5 shows the simulation and components of the apparatus for enhancing the performance of fuel combustion

FIG. 6 shows the diagram of the simulation of the disassociation of gas molecules when flowing through the apparatus by using “ [symbol] ” to represent fuel molecules

FIG. 7-8 shows the components of the

FIG. 9 shows the characteristics of usage.

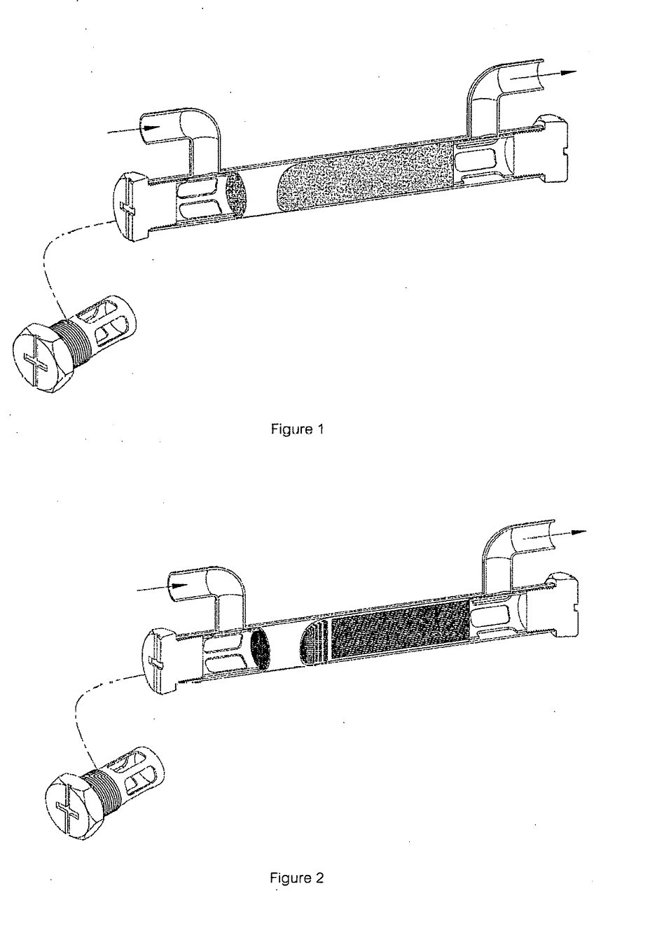

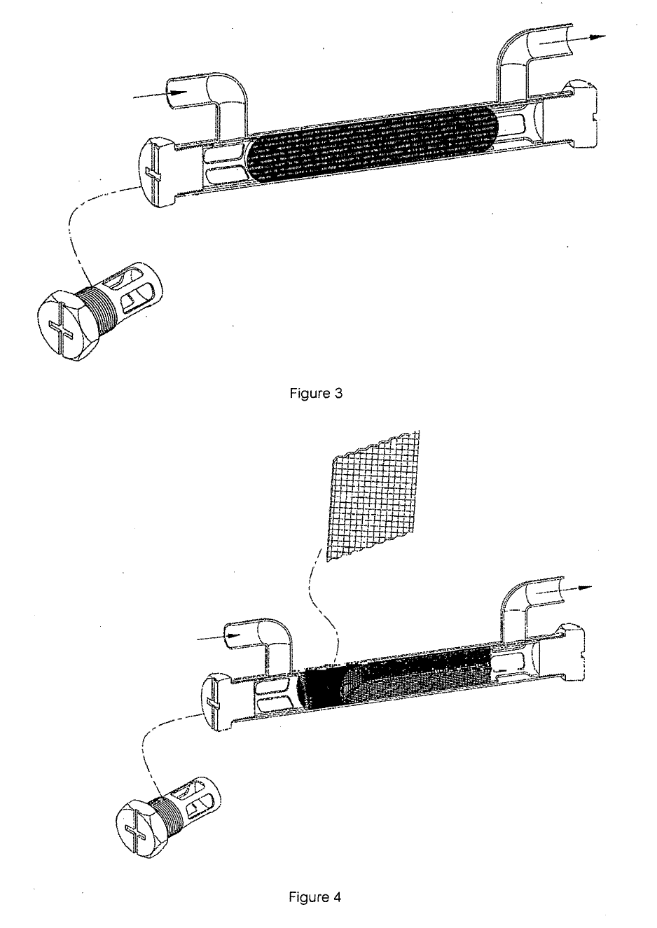

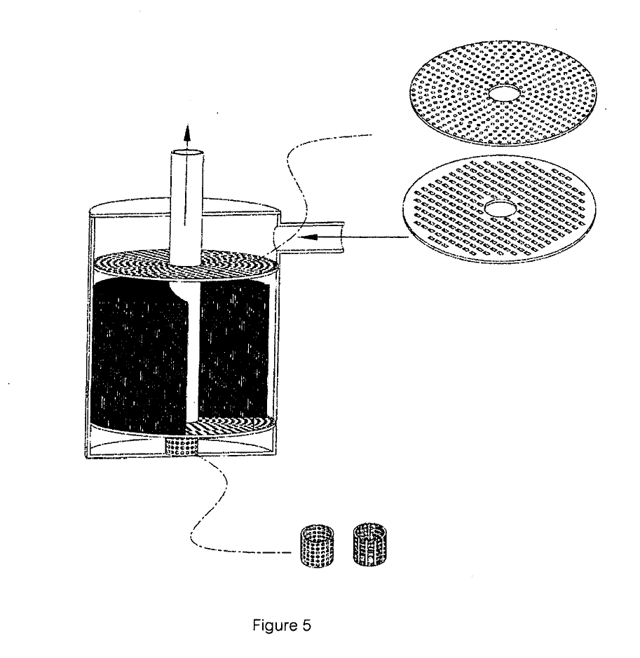

### DETAILED DESCRIPTION OF THE PREFERRED EMBODIMENT

For a better understanding of the preferred embodiment and to show how it may be performed, it will now be described in more detail by way of examples only with reference to the accompanying drawings. The parts shown in the drawings will be represented by the referenced number. The description, however, does not imply to any limitation and the scope of the invention will be in accordance with the claims attached herein.

This invention increases the combustion performance of fuel and increases the heat by reducing the static electrical charges between molecules, thereby reducing the electrical charges occurring from the flow of fuel and air. The invention as disclosed herein will allow the better distribution of gas mass. The spaces between the molecules of gas mass that can contact oxygen will increase and enhance its flammable property and allow complete combustion. With the same amount of gas used, the heat and energy obtained will also increase.

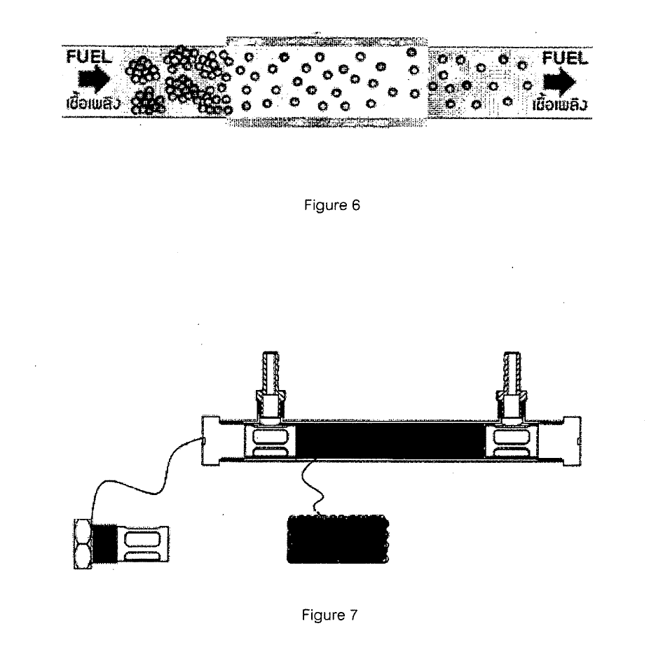

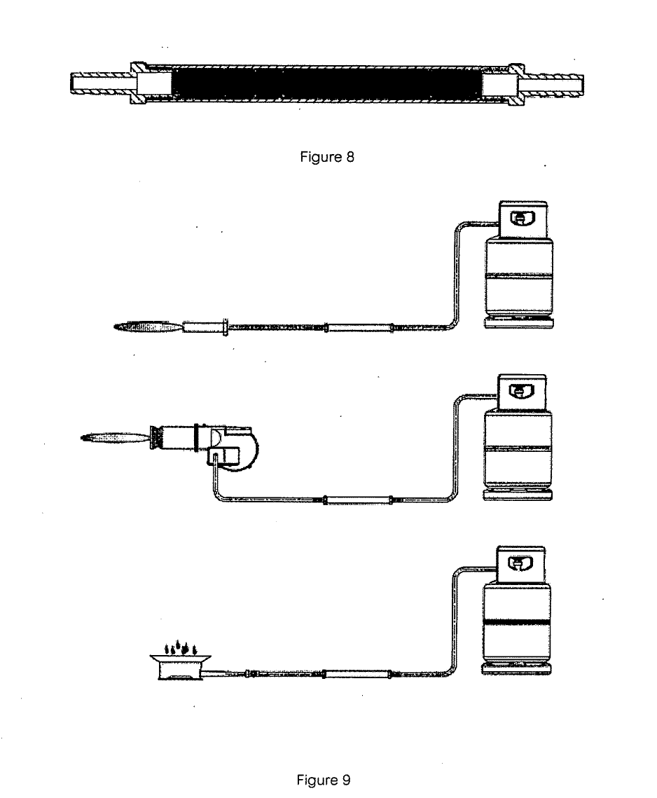

The diagram simulating the disassociation of gas molecules when flowing through the apparatus is shown in FIG. 6. When gas flows through the apparatus according to this invention, the gas molecules will be disassociated and become independent of each other. Gases that used to gather together due to the static charges occurring through the flow of fuel will now disassociate and have better contact with air (oxygen). This will allow complete combustion and an increase in heat.

The apparatus comprises a tube portion made of metal or non-metal that has the ability to reduce static charges in fuel (electrostatic neutralization). If it is a metal tube, the metals will be those that have the value of electron affinity (which is the energy required to remove electrons from gaseous anion) more than 14 KJ/mol. selected from iron, aluminium tin, nickel, bronze, silver, platinum, or gold that have the value of electron affinity namely 14.63 KJ/mol., 41.86 KJ/mol., 107.3 KJ/mol., 111.6 KJ/mol., 119.24 KJ/mol., 125.86 KJ/mol., 205.04 KJ/mol. and 222.75 KJ/mol. respectively.

The portion that has a characteristic of coil filaments in the tube is provided in order to reduce the direct contact with fuel or fluid inside the tube. If it is a metal tube, the metals will be those that have the value of electron affinity (which is the energy required to remove electrons from gaseous anion) more than 14 KJ/mol. selected from iron, aluminium tin, nickel, bronze, silver, platinum, or gold that have the value of electron affinity namely 14.63 KJ/mol., 41.86 KJ/mol., 107.3 KJ/mol., 111.6 KJ/mol., 119.24 KJ/mol., 125.86 KJ/mol., 205.04 KJ/mol. and 222.75 KJ/mol. respectively. The said filaments may have to be burned at an appropriate temperature in order to be in the oxide situation that may contribute to better combustion. This portion can be replaced when expired according to the usage shown in drawings No. 7 and 8. When used, it can be installed at the position within 1 meter from the burner or a regular gas stove in order to achieve the maximum performance as shown in the FIG. 9. The appropriate flow rate is approximately 1 millisecond, per meter.

Additionally, from the test of the water evaporation rate per volume of gas fuel, it was found that the testing kit utilizing the bronze wires will save fuel for boiling water at a rate of more than 20 percent compared to the regular amount of fuel required.

The test of the water evaporation rate per volume of gas fuel

| | | | Burned | | Normal | | | |
|---|---|---|---|---|---|---|---|---|
| | | | bronze | | case | | | |
| | | ERS | wires | | without | | | |
| | | (supplier) | large | small | apparatus | Saving | | |
| | | Test 1 | Test 2 | Test 3 | Test 4 | ERS/Nor | L/nor | Small/Nor |
| Test 1 | 12/6/2013 | 35.33 | | | 28.37 | | | |
| | 13/6/2013 | 34.62 | | | 30.02 | | | |
| | 14/6/2013 | 30.14 | | | 28.95 | | | |
| | min | 30.14 | | | 28.37 | | | |
| | max | 35.33 | | | 30.02 | | | |
| | average | 33.36 | | | 29.11 | 14.6% | | |
| Test 2 | 31/8/2013 | 35.04 | 33.67 | 36.93 | 27.46 | | | |
| | 3/9/2013 | 37.08 | 36.59 | 36.65 | 33.68 | | | |
| | 5/9/2013 | 37.04 | 34.41 | 35.14 | 33.15 | | | |
| | 6/9/2013 | 38.72 | 34.95 | 37.35 | 33.97 | | | |
| | 7/9/2013 | | repeat | | 23.71 | | | |
| | 7/9/2013 | | repeat | | 24.37 | | | |
| | min | 35.04 | 33.67 | 35.14 | 23.71 | | | |
| | max | 38.72 | 36.59 | 37.35 | 33.97 | | | |
| | average | 36.97 | 34.91 | 36.52 | 29.39 | 25.8% | 18.8% | 24.2% |

| | |
|---|---|
| Total repeat | 29.39 |

It will be appreciated by persons skilled in the art that the present inventions are not limited by what has been particularly shown described hereinabove. Rather the scope of the present invention includes both combinations and sub-combinations of the features described hereinabove as well as modifications and variations thereof which would occur to a person of skill in the art upon reading the foregoing description and which are not in the prior art.

1. Apparatus for enhancing performance of fuel combustion comprising
a tube made from metal or non-metal
filaments contained and arranged within the said tube made of the metal or non-metal materials having the property of reducing static charges
wherein the filaments are woven as a net and said net is arranged to be positioned along the tube wall inside the tube.

2. Apparatus for enhancing performance of fuel combustion as cited in claim 1 wherein the filaments are woven in the form of a rectangular-shaped net or a rhombus-shaped net.

3. Apparatus for enhancing performance of fuel combustion as cited in claim 1 wherein the filaments are round wires or flat wires.

4. Apparatus for enhancing performance of fuel combustion as cited in claim 1 wherein filaments are woven as a net and said net is arranged to be positioned along the tube wall inside the tube in the form of a cylinder.

5. Apparatus for enhancing performance of fuel combustion as cited in claim 1 wherein filaments are woven as a net and said net is arranged in the woven form and positioned along the tube wall inside the tube.

6. Apparatus for enhancing performance of fuel combustion as cited in claim 1 wherein the metal used for making the tube or filament is selected from at least one from the group of iron, aluminium tin, nickel, bronze, silver, platinum, or gold.
